(19) United States
(12) Patent Application Publication
(10) Pub. No.: US 2002/0110511 A1
(43) Pub. Date: Aug. 15, 2002

(54) Horizontal scrubber system

(76) Inventors: Jonas Klingspor, Austin, TX (US); David Colley, Austin, TX (US); Sterling Gray, Austin, TX (US); Greg Brown, Round Rock, TX (US); Phil Lowell, Austin, TX (US)

Correspondence Address: KLAUBER & JACKSON, 411 HACKENSACK AVENUE, HACKENSACK, NJ, 07601

(21) Appl. No.: 10/002,881

(22) Filed: Nov. 2, 2001

Related U.S. Application Data
(60) Provisional application No. 60/245,305, filed on Nov. 2, 2000.

(51) Int. Cl. B01D 53/50; B01D 53/14

(52) U.S. Cl. 423/243.08; 96/234; 96/235; 96/270; 96/322; 95/195; 95/235

(57) ABSTRACT

A scrubber system is provided which enables a substantially horizontal flow path for the gas which is being subjected to scrubbing. Among other advantages, this permits operation of the absorber with a differential pressure of zero or less. Scrubber composition spray means are positioned in the horizontal gas flow path for spraying an aqueous scrubber composition in a direction which is generally cocurrent with said gas flow. The system is free of means which spray the scrubber composition in directions countercurrent to said gas flow.

### RELATED APPLICATION

This application claims priority from Applicant's provisional patent application, filed Nov. 2, 2000 under Serial No. 60/245,305.

### FIELD OF INVENTION

This invention relates generally to apparatus for desulfurization of flue gases, and more specifically relates to an improved scrubber system which enables effective use of a horizontally oriented gas flow path for the gas being treated in the apparatus. The system characteristics are such as to permit operation of the absorber with a differential pressure drop of zero or less.

### DESCRIPTION OF PRIOR ART

### BACKGROUND OF THE INVENTION

Air pollution is a very serious and urgent international problem. The sources of air pollution are primarily the products of combustion and are numerous and widespread. Many of the air pollutants are in the form of sulfur-bearing flue gases discharged by fossil-fuel-burning electrical power generating plants or other industries. While the precise impact of these pollutants on the environment is still a subject of some speculation, evidence continues to mount which demonstrates serious adverse effects. Yet, under foreseeable circumstances, it will be necessary to burn more and more fuel to meet the demands of a rapidly growing population requiring for each person ever more heating comfort and power, and the fuel which will generally be used will not contain much less sulfur, but will likely contain more sulfur.

Thus, sulfur oxides, principally present as sulfur dioxide, are found in the waste gases discharged from many metal refining and chemical plants, and in the flue gases from power plants generating electricity by the combustion of fossil fuels. In addition, sulfur-containing gases, notably sulfur dioxide, may be formed in the combustion of sulfur-containing fuels, such as coal or petroleum residues. The control of air pollution resulting from the discharge of sulfur dioxide into the atmosphere has thus become increasingly urgent.

As used herein the term “flue gas” is meant to encompass all of the foregoing gaseous discharges. It should additionally be noted that while sulfurous gases (notably sulfur dioxide) are the principal contaminants of concern, further undesirable components are usually present in the sulfurous flue gases, including acid halogen gases such as hydrogen chloride, as well as carbon dioxide and monoxide. The present invention will be seen to be useful in removing certain of these further gases from the flue gas, i.e., in addition to the sulfurous gases, and thus the term “flue gas desulfurization” as used herein, should not be interpreted to imply that only sulfurous components are removed by the invention.

The most common flue gas desulferization (FGD) process is known as the “wet process”. In that process the sulfur dioxide-containing flue gas is scrubbed with a slurry containing, e.g., limestone. The scrubbing takes place, for example, in an absorption tower in which the gas flow is countercurrent to and in intimate contact with a stream i.e. a spray of slurry. Most commonly the slurry is made to flow over packing or trays. The spent slurry product of this FGD process contains both calcium sulfite and calcium sulfate. It has been found to be advantageous to convert the calcium sulfite in the product to calcium sulfate by bubbling air or other oxygen-containing gas through the slurry. In addition to calcium based scrubbing compositions, it is well-known to utilize ammonium or sodium based scrubbing reagents. Accordingly as used herein the term “scrubber composition” is intended to encompass all of these conventional scrubber compositions, including clear aqueous liquors of e.g., ammonium sulfate; and aqueous slurries, e.g., of calcium carbonate, calcium sulfate or ammonium sulfate.

### SUMMARY OF INVENTION

Briefly, and in accordance with the present invention, a scrubber system is provided which enables a substantially horizontal flow path for the gas which is being subjected to scrubbing. Among other advantages, this permits operation of the absorber with a differential pressure of zero or less.

Existing cocurrent absorber designs require packing to achieve reasonable SO₂ removal efficiencies. The presence of this packing results in a positive differential pressure inlet-to-outlet (i.e., a net pressure drop) for the treated flue gas across the absorber which requires a booster fan or booster fan modification to overcome. Other absorber designs also result in a significant flue gas pressure drop and thus have the same booster fan requirement. In accordance with the present invention it has been found possible to even achieve a pressure rise in a cocurrent absorber if no packing material is included.

With the packing removed, gas flowing through the absorber will have momentum transferred to it by the slurry spray and the gas pressure can actually rise across the absorber (i.e., the absorber will have a negative pressure drop). Thus, it is feasible to install a cocurrent absorber without the addition of a special booster fan or with minimum modification of an existing fan. A design such as this is especially useful for FGD retrofit applications, eliminating the need for expensive fan modifications.

Another advantage of the cocurrent absorber design in retrofit applications is that cocurrent absorbers can be operated at higher gas velocities than countercurrent absorber designs. This advantage has two related benefits. First, the absorber cross-section can be smaller for cocurrent absorbers than for countercurrent absorbers. Thus, less space is required, which can be especially important in retrofit applications where available space is at a premium. Secondly, the “turn-up” ratio for cocurrent absorbers is better than for countercurrent absorbers. That is to say, the gas flow rate can be increased with less deleterious impact on performance for cocurrent absorbers than for countercurrent absorbers. Thus, it is easier to take a scrubber module “out of service” and treat all of the gas in the remaining on-line absorbers.

### BRIEF DESCRIPTION OF THE DRAWINGS

In the drawings:

FIG. 1 is a schematic cross-sectional view of a first embodiment of a cocurrent scrubber system in accordance with the invention;

FIG. 2 is a schematic cross-sectional view of a second embodiment of a cocurrent scrubber system in accordance with the invention;

FIG. 3 is a schematic cross-sectional view of a third embodiment of a cocurrent scrubber system in accordance with the invention; and

FIG. 4 is a schematic cross-sectional view of a fourth embodiment of a cocurrent scrubber system in accordance with the invention.

### DESCRIPTION OF PREFERRED EMBODIMENTS

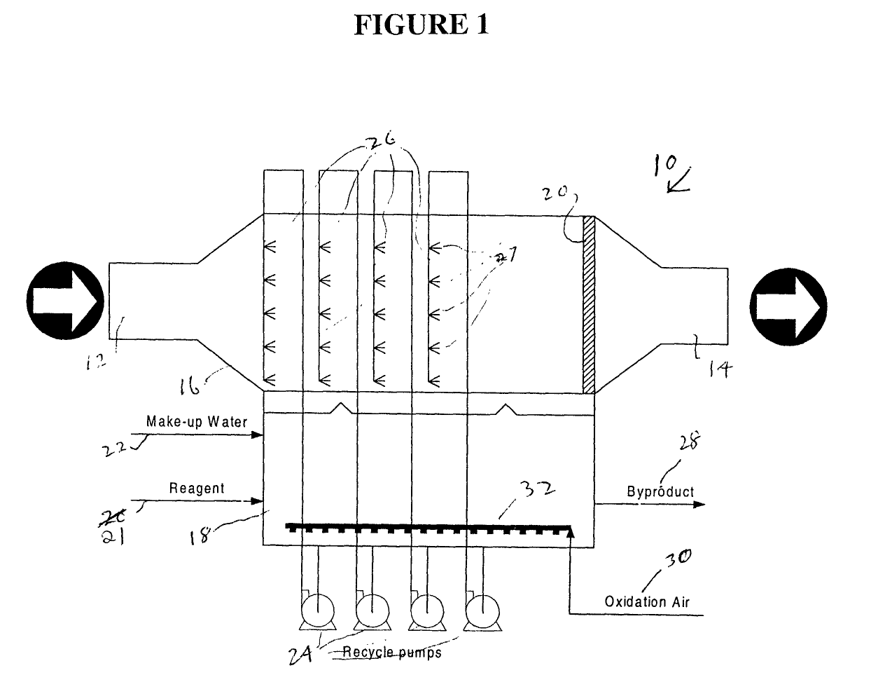

The general features of the scrubbing systems of the present invention are illustrated in FIG. 1. The system 10 shown therein is characterized by several new and innovative features. A major such feature is the horizontal gas path which makes the scrubber very compact and provides a very low profile. The gas paths leading into the scrubber and leaving from the scrubber are very simple and can connect to an upstream particulate control device or possible booster fan without complicated duct runs. Similarly, the outlet duct can be connected through a straight duct run with the stack.

The gas velocity at the inlet 12 to and exit 14 from the scrubber will typically be in the range of 50 to 60 fps. The velocity inside the scrubber will typically be between 20 to 30 fps.

The scrubber spray zone 16 is integrally connected to the reaction tank 18. Spray introduced into the scrubber path will fall by gravity into the reaction tank. The reaction tank 18 spans the entire gas path of the scrubber module. A one-stage or two-stage mist eliminator 20 is located at the end of the scrubber gas path to control entrained emissions of liquid droplets. This design is considered to be very cost efficient.

Reagent 21 and make-up water 22 is added to the reaction tank 18 as needed based on pH and level. The reagent used can e.g., be the aforementioned limestone, in which event the resulting aqueous scrubber composition is a limestone slurry, typically containing e.g., 10-25% solids. The scrubber composition in the reaction tank 18 is put in contact with the gas path by means of multiple recycle pumps 24 that serve individual spray headers 26 located in the gas path. Flue gas sulfur dioxide (as well as the acid halogen gases such as Hcl) is absorbed into the spray and the chemical reactions are allowed to be completed in the reaction tank including dissolution of the reagent, oxidation of the byproduct via oxidation air 30 provided to sparge ring 32 and crystallization of the byproduct, e.g., gypsum which is removed at 28.

The spray headers 26 are located perpendicular to the gas path and span the entire cross section of the gas path. Four rows of such headers are representatively shown; the number can vary depending upon system requirements. Spray nozzles 27 distributed across the spray headers 26 are used to atomize the recycle solution. Since the headers extend into the plane of FIG. 1, spray nozzles 27 actually form a series of matrices. The spray nozzles 27 introduce the recycle solution in a direction which is generally cocurrent with the gas flow and are specifically designed to generate a draft through the scrubber such that the pressure drop through the scrubber is eliminated, or there may actually be a pressure rise. This is achieved by the cocurrent spray, the nozzle spray angle, distribution of spray nozzles 27, pressure drop across the spray nozzles 27, and the spray pattern from the spray nozzles. The spray angle is typically 40 degrees but can vary from 20 to 120 degrees. The nozzle distribution is such as to provide an even distribution of recycle solution. Typically 200 gpm nozzles are used but the nozzle size can vary from 100 gpm to 400 gpm. The pressure drop across the spray nozzles is typically 20 psi but can vary from 8 psi to 40 psi. The spray pattern is typically full cone but semi full cones from spiral nozzles are also acceptable. It is important that the nozzles 27 be efficient in converting the fluid pressure to velocity

The draft generated in the scrubber eliminates the need for a booster fan, simplifying and reducing the cost of retrofitting scrubbers to existing boilers. Many existing boilers typically do not have enough fan capacity to accommodate the pressure drop associated with a scrubber retrofit.

Sparge ring 32 is designed to introduce oxidation air and to provide agitation of the reaction tank composition. The sparge ring 32 is basically a ring header submersed in the reaction tank 18 and located between 1 and 2 feet of the bottom of the reaction tank. The ring header can be circular, square, or otherwise, depending upon the geometry of the tank. The sparge ring header has a multitude of penetration points which ejects compressed air into the slurry. The main purpose of the ring header is to provide oxidation air for oxidation of liquid phase sulfite ions to sulfate ions. A secondary but very important function of the sparge ring 32 is to agitate the slurry in the reaction tank so that no or very limited buildup of solids occur on the reaction tank floor. This avoids the need for separate agitators and corresponding equipment installation and maintenance.

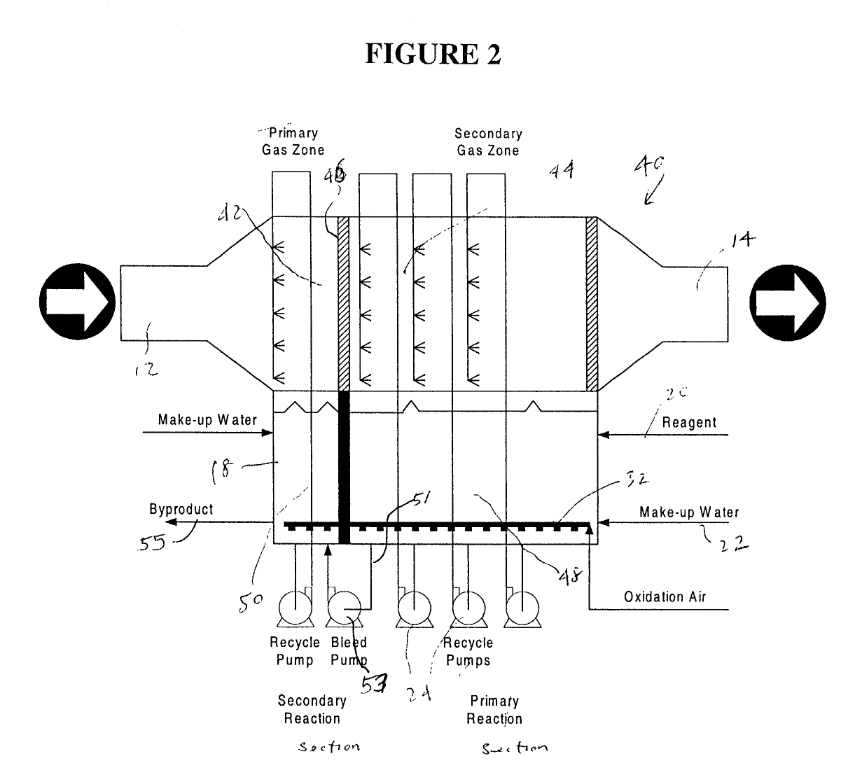

FIG. 2 illustrates an embodiment of the invention, which is particularly applicable to double loop operation. Components of the system 40 corresponding to those in system 10 are identified by the same reference numerals.

This alternative is particularly designed to provide a byproduct which is very pure and a chemistry in the main spray zone which is free from chlorides (and fluorides) and hence very reactive and efficient in removing flue gas sulfur dioxide.

The spray zone is divided into a primary gas zone 42 and a secondary gas zone 44, separated by a one-stage mist eliminator 46. Similarly, the reaction tank 18 is separated by vertical partition 19 into a primary reaction section 48 and a secondary reaction section 50. Recycle solution entering the primary gas zone is prevented from entering into the secondary gas zone by the mist eliminator 46 and liquid captured by the mist eliminator is returned to the secondary reaction section 50. The primary gas zone 42 primarily captures flue gas hydrochloric acid (hydrogen chloride gas) and (if present) flue gas fly ash. No reagent is directly added to the secondary reaction section 50. The only reagent entering the secondary reaction tank comes with the byproduct bleed from primary reaction section 48 which proceed at 51 via bleed pump 53. The secondary reaction section 50 operates at a lower pH compared to the primary reaction tank, providing an environment for quick dissolution of residual reagent and hence production of a pure byproduct 55 (e.g. gypsum). The chlorides and/or fluorides exit as well at 55, and are subsequently washed from the filter cake (e.g., of gypsum).

Partition of the gas path is very easy and cost effective in a horizontal tower as compared to a vertical tower, which requires considerably more structural components to achieve the same task.

The reagent 20 (typically limestone) is added to the primary reaction section 48 and the aqueous reagent laden recycle slurry is introduced as a spray into the secondary gas zone by the recycle pumps 24 and the nozzles 44 connected to these pumps. The pH in the recycle slurry can be fairly high as no chlorides are present and therefor the slurry can be very efficient in absorbing flue gas sulfur dioxide. In the design phase, this provides an opportunity to reduce the capacity and cost of the recycle pumps to achieve the required efficiency of the scrubber.

This embodiment also generates a positive draft and a booster fan is not required to push the flue gas through the scrubber.

The primary and secondary reaction tanks are again equipped with the aforementioned sparge ring 32. Separate oxidation in both tanks is required to control the scaling potential in the secondary reaction tank.

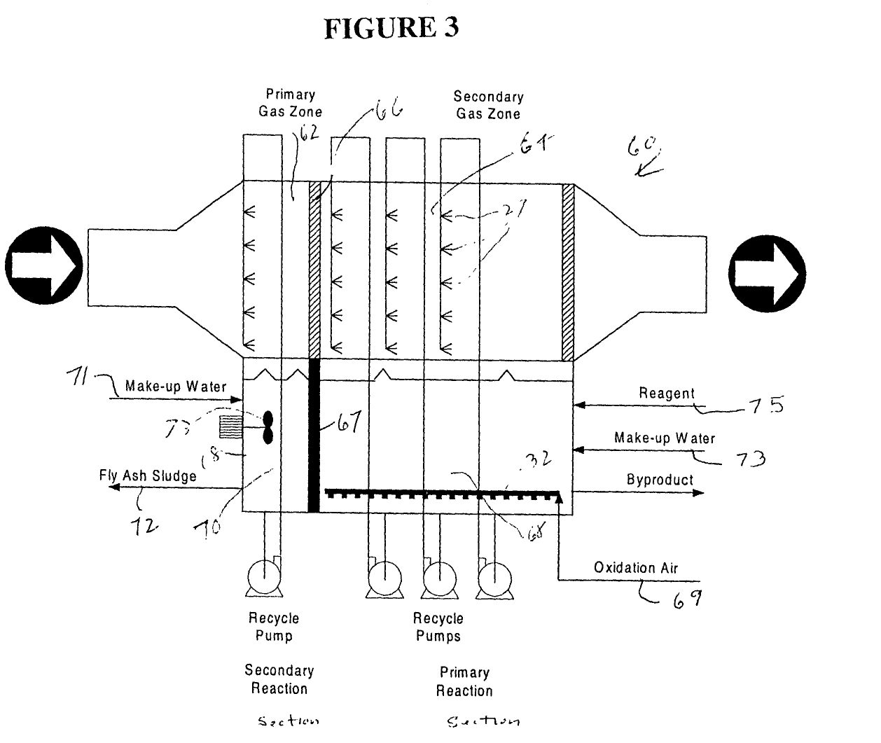

FIG. 3 illustrates an embodiment of the invention which is particularly applicable to remove residual fly ash in the flue gas ahead of the main scrubbing step to avoid costly upgrades of the station's existing particulate control devices and to produce a byproduct which is very pure. Components of the system 60 corresponding to those in system 10 are identified by the same reference numerals.

The spray zone is divided into a primary gas zone 62 and a secondary gas zone 64 separated by a one-stage mist eliminator 66. Similarly, the reaction tank 18 is separated by vertical partition 67 into a primary reaction section 68 and a secondary reaction section 70. The secondary reaction section 70 is provided with a side mounted agitator 73. The scrubbing compositions of the primary reaction section 68 and the secondary reaction section 70 are kept completely separate. Recycle solution entering the primary gas zone 62 is prevented from entering into the secondary gas zone by the mist eliminator 66 and liquid captured by the mist eliminator is returned to the secondary reaction section 70. Oxidation air 69 is provided to sparging ring 32 which is present only in primary reaction section 68. Oxidation air is not provided to secondary reaction section 70 as oxidation is not required there. Essentially only water 71 is provided to section 70. The secondary reaction section 70 solution is introduced into the primary gas zone 62 primarily to remove flue gas fly ash 72 and flue gas hydrochloric (or other halogen) acid. The primary reaction section composition again is typically an aqueous slurry of water 73 and as a reagent 75, limestone. This slurry is introduced in the secondary gas zone primarily to remove flue gas sulfur dioxide.

In a vertical tower arrangement, two separate scrubbing towers and associated equipment and duct work would be required to achieve the same result. The horizontal tower configuration is very simple and eliminates costly equipment. This design also generates a positive draft and a booster fan is not required to push the flue gas through the scrubber.

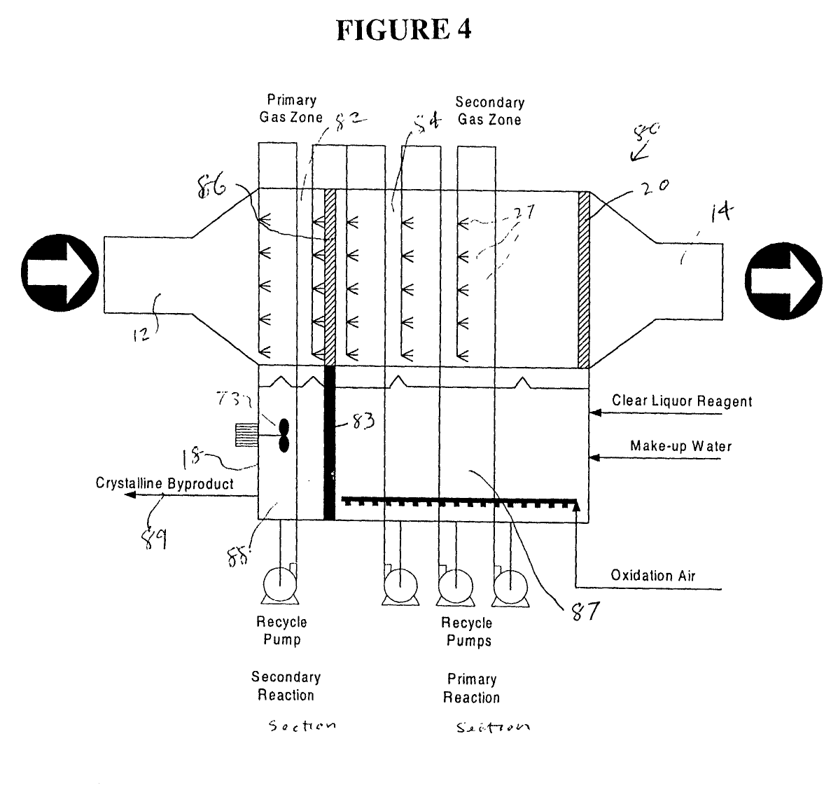

The embodiment of the invention shown in FIG. 4 is particularly designed to use flue gas heat to evaporate water from a clear liquor scrubbing solution such as ammonium sulfate while maintaining a clear liquor operation in the main scrubbing zone. This offers three distinct advantages, (1) flue gas heat can be used to evaporate water eliminating the use of other costly energy sources, (2) clear liquor operation in the main scrubbing zone eliminates the potential for plugging and scaling as well as physical wear and tear on rotating equipment, and (3) the need for separate crystallization equipment is obviated. Components of the system 80 corresponding to those in system 10 are identified by the same reference numerals.

The spray zone in system 80 is again divided into a primary gas zone 82 and a secondary gas zone 84 separated by a one-stage mist eliminator 86. Similarly, the reaction tank is separated by vertical partition 83 into a primary reaction section 87 and a secondary reaction section 88. As in FIG. 3, the sparger ring 32 provides oxidation air to primary reaction section 87, but no oxidation air is provided to secondary section 88. Recycle solution entering the primary gas zone 82 is prevented from entering into the secondary gas zone 84 by the mist eliminator 86 and liquid captured by the mist eliminator 86 is returned to the secondary reaction section 88. The secondary gas zone and the primary reaction section 87 operate with a clear liquor solution, e.g. around 30 percent ammonium sulfate. Complete oxidation is achieved at the primary reaction section 68 via air from sparge ring 32.

Byproduct solution is bled from the primary reaction section 87 to the secondary reaction section 88 by means of washing the intermediate mist eliminator 86 with solution from the primary reaction section 87. The solution in the secondary reaction section 88 is allowed to operate above the saturation point by evaporating water from the solution using the sensible heat of the flue gas. The crystals generated in the secondary reaction section 88 can be recovered by passing a bleed stream 89 from the secondary reaction section 88 through a hydrocyclone and returning the clear overflow to the secondary reaction section 88. The agitator 73 serves to inhibit settling of solids in secondary reaction section 88. This design also generates a positive draft and a booster fan is not required to push the flue gas through the scrubber.

While the present invention has been described in terms of specific embodiments thereof, it will be understood in view of the present disclosure, that numerous variations upon the invention are now enabled to those skilled in the art, which variations yet reside within the scope of the present teaching. Accordingly, the invention is to be broadly construed, and limited only by the scope and spirit of the claims now appended hereto.

1. A flue gas desulfurization system comprising:
a) a scrubber section having an inlet and an outlet for said flue gas with a substantially horizontal flow path for said gas being defined between said inlet and outlet;
b) scrubber composition spray means positioned in said horizontal gas flow path for spraying an aqueous scrubber composition in a direction which is generally cocurrent with said gas flow; said system being free of means which spray said scrubber composition in directions generally countercurrent to said gas flow
c) a reaction tank underlying said scrubber section and in open communication therewith for providing a reservoir for said scrubber composition, for receiving the scrubber composition which has contacted said flue gas and gravitationally descended to said tank from said scrubber section, and for receiving the reaction products of said flue gas and scrubber composition;
d) means for pumping the scrubber composition from said reaction tank to said spraying means;
e) means for removing said reaction products from said reaction tank; and
f) means for replenishing the scrubber composition contained in said reaction tank.

2. A system in accordance with claim 1, further including means for introducing oxidation air into said reaction tank.

3. A system in accordance with claim 2 wherein said scrubber section comprises a primary and a secondary gas zone in series in the gas flow path, said zones being separated by a mist eliminator; said reaction tank being separated by a vertical partition into a secondary and a primary reaction section, which reaction sections respectively underlie and are in open communication with said primary and secondary gas zones; and wherein said pumping means comprises separate pumps for spraying aqueous scrubber composition from the secondary reaction tank into the primary gas zone and for spraying aqueous scrubber composition from the primary reaction section into the secondary gas zone

4. A system in accordance with claim 2, further including means to bleed aqueous scrubber composition from said primary reaction section to said secondary reaction section, and wherein said reaction products are removed from said secondary reaction section.

5. A system in accordance with claim 2, wherein said oxidation means is present only in said primary reaction section.

6. A system in accordance with claim 5, including agitation means for inhibiting settling of solids which are present in said secondary reaction section.

7. A system in accordance with claim 6, further including bleed means to bleed aqueous scrubber composition from said primary reaction section to said secondary reaction section.

8. A system in accordance with claim 7, wherein said bleed means is connected to wash the mist eliminator between said primary and secondary gas zones with said aqueous scrubber composition from said primary reaction section

9. A method for desulfurizing flue gas comprising:
a) flowing said flue gas through a scrubber section having an inlet and an outlet for said flue gas with a horizontal flow path for said gas being defined between said inlet and outlet;
b) contacting the flowing flue gas at said scrubber section with an aqueous scrubber composition by spraying the composition solely in a direction generally cocurrent with said gas flow;
c) providing a reaction tank underlying said scrubber section as a reservoir for the scrubber composition and for collecting the scrubber composition which has contacted said flue gas and gravitationally descended to said tank, together with the reaction products of said flue gas and scrubber composition;
d) utilizing the scrubber composition from said reaction tank in said spraying contact with said flue gas;
e) removing said reaction products from said reaction tank; and
f) replenishing the scrubber composition contained in said reaction tank.

10. A method in accordance with claim 9, further including introducing oxidation air into said reaction tank.

11. A method in accordance with claim 10, wherein said scrubber section includes a primary and a secondary gas zone in series in the gas flow path, said zones being separated by a mist eliminator; said reaction tank being separated by a vertical partition into a secondary and a primary reaction section which reaction sections respectively underlie and are in open communication with said primary and secondary gas zones; and wherein aqueous scrubber composition from the secondary reaction tank is sprayed into the primary gas zone and aqueous scrubber composition from the primary reaction section is sprayed into the secondary gas zone.

12. A method in accordance with claim 11, wherein the scrubber composition is a limestone slurry and wherein reaction product is removed from said secondary reaction section; the pH in said secondary reaction section being sufficiently acid to dissolve calcium carbonate, whereby the gypsum product formed at said reaction tank from reaction of the scrubbing composition with sulfurous components of said flue gas can be withdrawn from said secondary reaction section relatively free of precipitated carbonates generated from reaction of the scrubbing composition with small quantities of carbon dioxide present in said flue gas.

13. A method in accordance with claim 11, wherein the scrubber composition sprayed into said secondary gas zone is a limestone slurry and wherein a predominantly gypsum reaction product formed at said reaction tank from reaction of the scrubbing composition with sulfurous components of said flue gas is removed from said primary reaction section; the said oxidation air being introduced only into said primary reaction section, and the scrubber composition sprayed into said primary gas zone being primarily water, whereby hydrogen chloride and other acidic halogen gases contained in said flue gas are washed from said flue gas at said primary gas zone.

14. A method in accordance with claim 13, further including agitating the contents of said secondary reaction section to inhibit settling of fly ash particulates which are derived from the incoming flue gas; and withdrawing of fly ash sludge from said secondary reaction section.

15. A method in accordance with claim 11, wherein the scrubber composition sprayed into said secondary gas zone is a clear solution of ammonia, said oxidation air being introduced only into said primary reaction section, and wherein a solution of ammonium sulfate reaction product is pumped from said primary reaction tank and sprayed into said primary gas zone together with scrubber composition from said secondary reaction section; the flue gas flowing through said primary gas zone being quenched by the sprays to a sufficiently low temperature to enable the ammonium sulfate entering said secondary reaction section to crystalize; and withdrawing the crystalized ammonium sulfate reaction product from said secondary reaction section.
